(19) United States
(12) Patent Application Publication
(10) Pub. No.: US 2013/0223869 A1
(43) Pub. Date: Aug. 29, 2013

(54) CONNECTION MECHANISM, DEVELOPMENT DEVICE, AND IMAGE FORMING APPARATUS

(71) Applicant: OKI DATA CORPORATION, (US)

(72) Inventor: Yukiyoshi ODA, Tokyo (JP)

(73) Assignee: OKI DATA CORPORATION, Tokyo (JP)

(21) Appl. No.: 13/771,450

(22) Filed: Feb. 20, 2013

(30) Foreign Application Priority Data
Feb. 24, 2012 (JP) 2012-038993

(51) Int. Cl. G03G 15/00; H01R 11/22

(52) U.S. Cl. CPC H01R 13/05; G03G 15/0832
USPC 399/90; 439/266

(57) ABSTRACT

A connection mechanism includes a connection member including a coil spring part and made by a conductor, a holding member that is configured to hold the coil spring part in a compressed state, and a relay member that is electrically connectable to the connection member. Wherein, the relay member is sandwiched between adjacent winding wires of the coil spring part to establish electrical connection.

### CROSS REFERENCE TO RELATED APPLICATION

The present application is related to, claims priority from and incorporates by reference Japanese Patent Application No. 2012-038993, filed on Feb. 24, 2012.

### TECHNICAL FIELD

The present invention relates to an image forming apparatus, such as an electrographic apparatus and the like, a development device that configures the image forming apparatus, and a connection mechanism that provides electrical connection.

### BACKGROUND

Conventionally, a configuration that uses a spring member to provide electrical connection between the spring member and other members is known (see, for example, JP Patent Laid-Open Application No. 2008-195512 (Pages 3 and 4, FIG. 3)).

However, in the conventional technologies, there are cases when stable electrical connection is not obtained.

### SUMMARY

One of connection mechanisms according to the present invention includes a connection member including a coil spring part and made by a conductor, a holding member that is configured to hold the coil spring part in a compressed state, and a relay member that is electrically connectable to the connection member. Wherein the relay member is sandwiched between adjacent winding wires of the coil spring part to establish electrical connection.

According to the present invention, the mounting of a relay member that is electrically connected to a connection member to a holding member and the electrical connection between the connection member and the relay member are securely accomplished by a simple configuration.

### BRIEF DESCRIPTION OF THE DRAWINGS

FIG. 1 is a schematic configuration diagram for explaining a configuration of a main part of an image forming apparatus of a first embodiment adapting the present invention.

FIG. 2 is a schematic configuration diagram schematically illustrating a black (K) development unit, a transfer member, an exposure device and a printed recording sheet.

FIG. 3 is an external perspective view of development devices of the first embodiment according to the present invention.

FIG. 4 is an external perspective view of the development devices of the first embodiment according to the present embodiment as viewed from a direction different from FIG. 3.

FIG. 5 is an external perspective view of the development devices in a state where four toner cartridges corresponding to various colors have been removed.

FIG. 6 is an external perspective view of the development devices in a state where four toner cartridges corresponding to various colors have been removed, as viewed from a direction different from FIG. 5.

FIG. 7 is an external perspective view of a single toner cartridge.

FIG. 8 is an external perspective view of a single toner cartridge as viewed from a direction different from FIG. 7.

FIG. 9 is an exploded perspective view illustrating a relative positional relationship between a first frame and a second frame in a slightly separated state.

FIG. 10 is an exploded perspective view illustrating a relative positional relationship between the first frame and the second frame in a slightly separated state, as viewed from a direction different from FIG. 9.

FIG. 11 is an exploded perspective view illustrating an electrical relay contact member provided on the first frame and the second frame in a separated state, as viewed from the same direction as FIG. 9.

FIG. 12 is an exploded perspective view illustrating the electrical relay contact member provided on the first frame and the second frame in a separated state, as viewed from the same direction as FIG. 10.

FIG. 13A is a configuration diagram of the first frame and the second frame as seen from the inside of a basket (negative side of Y axis). FIGS. 13B and 13C are partially enlarged view respectively enlarging parts indicated by arrows.

FIG. 14 is a configuration diagram illustrating the same part shown in FIG. 13B as rotated about the Y axis for ease of understanding (however, a first torsion spring is omitted). FIG. 14B is a cross-sectional view of a line A-A in FIG. 14A. FIG. 14C is an exploded perspective view of the same part (first connection part).

FIG. 15 is a dimensional diagram of the first connection part shown in FIG. 14C.

FIGS. 16A to 16D are diagrams for explaining mounting dimensions.

FIGS. 17A to 17D are diagrams for explaining mounting dimensions.

FIGS. 18A to 18D are diagrams for explaining mounting dimensions.

FIGS. 19A to 19D are diagrams for explaining mounting dimensions.

### DETAILED DESCRIPTION OF EMBODIMENTS

### First Embodiment

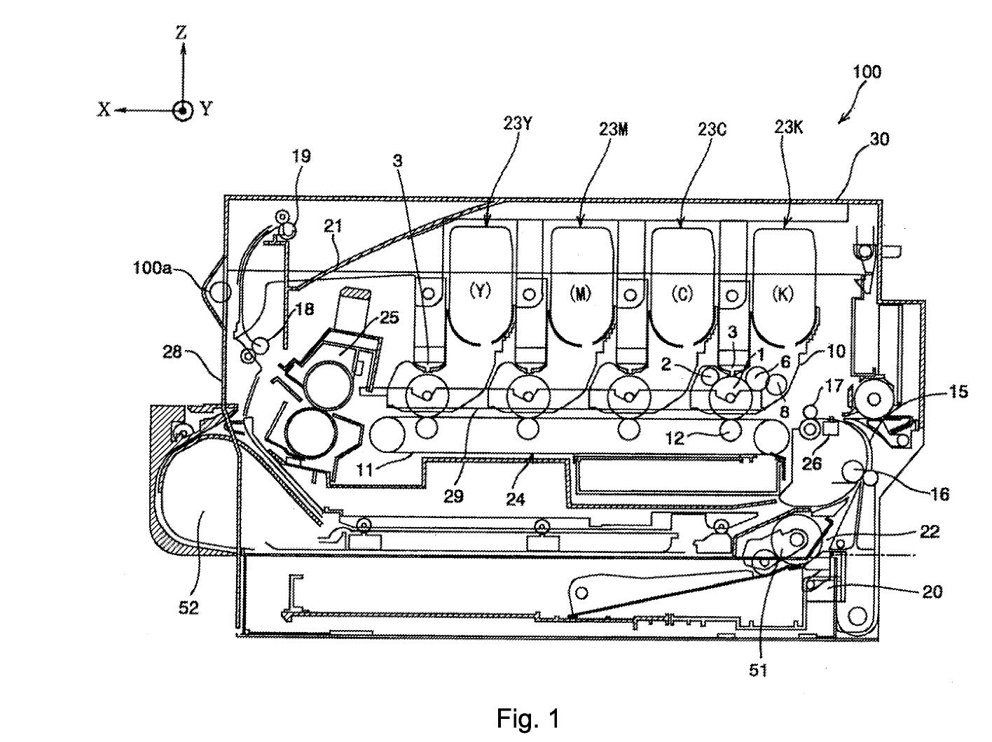

FIG. 1 is a schematic configuration diagram for explaining a configuration of a main part of an image forming apparatus of a first embodiment adapting the present invention.

In FIG. 1, an image forming apparatus 100 includes a configuration as a color electrographic type printer that is capable of printing in four colors, black (K), cyan (C), magenta (M) and yellow (Y). An approximately S-shaped sheet carrying path 15 that includes sheet carrying rollers 16 to 19 is formed in a flower frame 28. A sheet supply cassette 20 that accommodates recording sheets is positioned at the upstream end of the sheet carrying path 15, and a stacker 21 is provided at the downstream end of the sheet carrying path 15.

A sheet feeding part 22 that feeds the recording sheets from the sheet supply cassette 20, a detection part 26 that detects a sheet thickness of the recording sheets, a transfer belt unit 24 that attaches the fed recording sheet onto a transfer belt 11 by an electrostatic effect, and a fuser 25 that fixes a toner image on the recording sheets, are provided along the sheet carrying path 15.

Development units 23K, 23Y, 23M and 23C (referred to as a development unit(s) 23 unless otherwise specifically distinguished) that form images in black (K), cyan (C), magenta (M) and yellow (Y), respectively, are arranged in an array in the order from the upstream side of the carrying direction of the recording sheets that are carried by the transfer belt unit 24 as attached to the transfer belt 11, and at respective nip positions thereof. The development units 23K, 23Y, 23M and 23C are directly or indirectly and attachably to and detachablely from the image forming apparatus main body. Parts excluding components that are attachable/detachable or movable may be referred to as the image forming apparatus 100 main body.

By opening a top cover 30 of the image forming apparatus 100, the development unit 23, the fuser 25 and the transfer belt unit 24 can be replaced. In addition, an up-down lever 29 is a member for separating the development unit 23 that is unneeded for single color printing, from the transfer belt unit 24. A double-side print unit 52 reverses and feeds the recording sheet to the sheet carrying path 15 when performing double-side printing.

In the present embodiment, configuration of the development units 23K, 23C, 23M, 23Y is the same, except that the color of toner contained therein is different. Therefore, the internal configuration of the black (K) development unit 23K is explained below as an example.

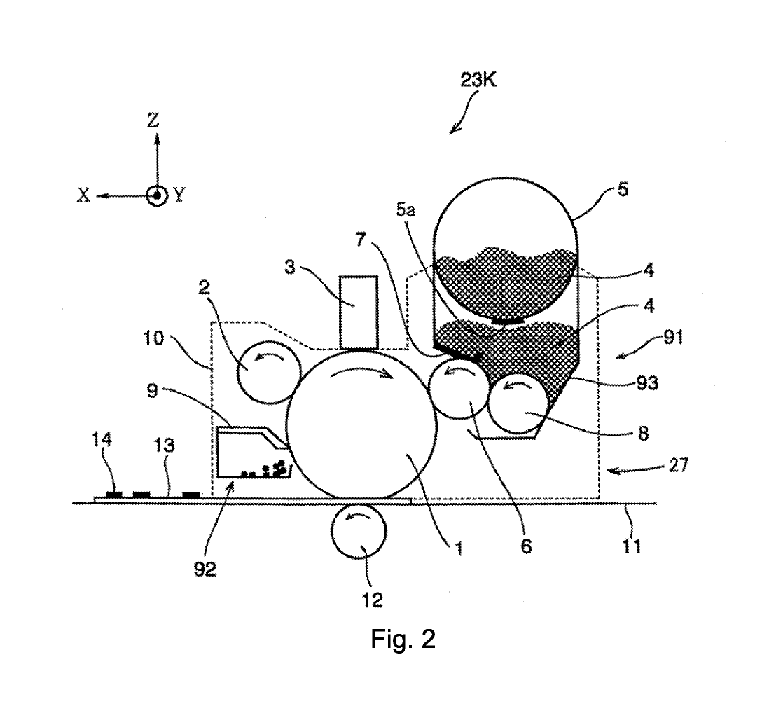

In FIG. 1, regarding X, Y and Z axes in FIG. 1, the X axis is in a carrying direction in which a recording sheet 13 (FIG. 2) passes the development unit 23. The Y axis is a rotational axis direction of a later-discussed photosensitive body 1. The Z direction is a direction orthogonal with the X and Y axes. In addition, when each of the X, Y and Z axes are shown in other figures discussed later, the directions of the axes are in the common directions. That is, the X, Y and Z axes indicate arrangement directions in which parts shown in the figure configures the image forming apparatus 100 shown in FIG. 1. Moreover, here, the Z axis is arranged in the approximately perpendicular direction.

FIG. 2 is a schematic configuration diagram schematically illustrating the black (K) development unit 23K, the transfer member, the exposure device and the printed recording sheet.

As shown in FIG. 2, the photosensitive body 1, as an image carrier, is arranged rotatably in the arrow direction in the development unit 23K. Around the photosensitive body 1, a charge roller 2 that charges the photosensitive body 1 by contacting the surface of the photosensitive body 1 at certain pressure and by supplying electric charge, and an exposure device 3 that irradiates light using a light source, such as a light emitting diode (LED) head and the like, to form an electrostatic latent image, are provided in the order from the upstream side of the rotational direction of the photosensitive body 1. The exposure device 3 is provided on the top cover 30 (FIG. 1) on the image forming apparatus 100 main body side.

Moreover, a development part 91 and a cleaning blade 9 are provided. The development part 91 generates a developed image on the surface of the photosensitive drum 1 on which the electrostatic latent image has been formed, by attaching toner of a predetermined color (here, black) on the surface of the photosensitive body 1. The cleaning blade 9 removes transfer remaining toner that remains on the photosensitive body 1 after transferring the toner developed image on the photosensitive body 1 onto the recording sheet 13 and causes the transfer remaining toner to fall into a waste toner collection part 92. Therefore, the cleaning blade 9 is formed of an elastic body. An edge part of the cleaning blade 9 is positioned so as to contact the surface of the photosensitive body 1 at certain pressure. The rotational bodies used in each of these devices rotate as a motive force is transmitted via gears from a drive source (not shown).

The development part 91 includes a toner cartridge 5 that supplies toner 4 from a tonner supply opening 5a formed at a lower part thereof, a toner storage part 93 that stores the toner 4 supplies from the toner cartridge 5, a development roller 6, a toner supply roller 8 that supplies the toner 4 to the development roller 6, and a development blade 7 that thins the toner 4 on the development roller 6. The development part 91 makes the electrostatic latent image formed on the surface of the photosensitive body 1 visible, and immediately develops the electrostatic latent image, by the toner 4. In addition, as discussed below, the development unit 23K is configured with the toner cartridge 5 that is detachably arranged above the toner supply roller 8. Hereinafter, the part of the development unit 23 that excludes the detachable toner cartridge 5 is referred to as a development unit main body 27. Outside of the development unit main body 27 is configured by mold 10.

The development roller 6 and the toner supply roller 8 are positioned in parallel with each other so as to contact each other at certain pressure and rotate in the respective arrow directions (same direction) as shown in FIG. 2. Moreover, as shown in FIG. 2, the development blade 7 and the development roller 6 are arranged in parallel with each other such that a folded part of the development blade 7 contacts the circumferential surface of the development roller 6 at a constant pressure. The rotational bodies used in each of these devices rotate as a motive force is transmitted via gears from a drive source (not shown).

As shown in FIG. 1, the transfer rollers 12 formed of conductive rubber and the like are positioned at a position facing the respective photosensitive bodies 1 in the above-described four development units 23 while being pressed against the photosensitive bodies 1 across via the transfer belt 11 that carries the sheet 13 (FIG. 2) by electrostatic suction. These transfer rollers 12 transfer the toner images on the photosensitive bodies 1. At the time of transfer, electric potential is applied to the transfer rollers 12 to provide a potential difference between the surface of the photosensitive bodies 12 and the surface of the transfer rollers 12 positioned to face the respective photosensitive body.

The fuser 25 includes a heat roller and a backup roller therein and fixes the transferred toner 14 transferred onto the recording sheet 13 (FIG. 2) by pressure and heat. The fixed recording sheet 13 is carried to the recording sheet stacker 21 by subsequent sheet carrying rollers 18 and 19.

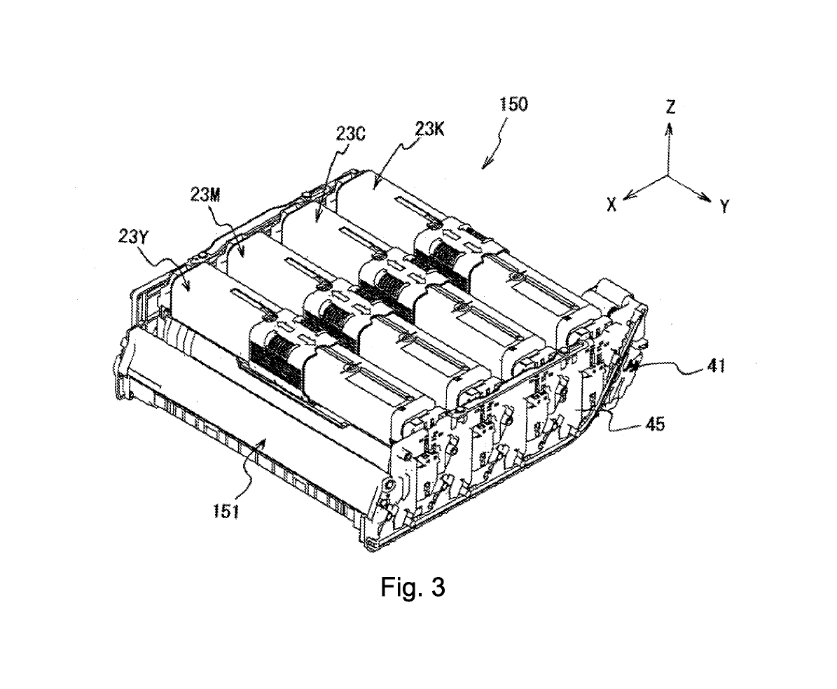

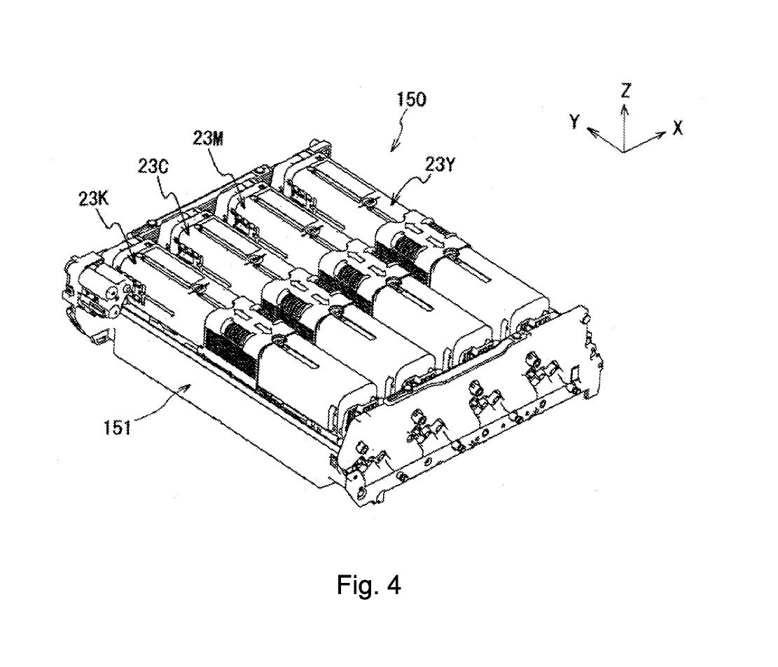

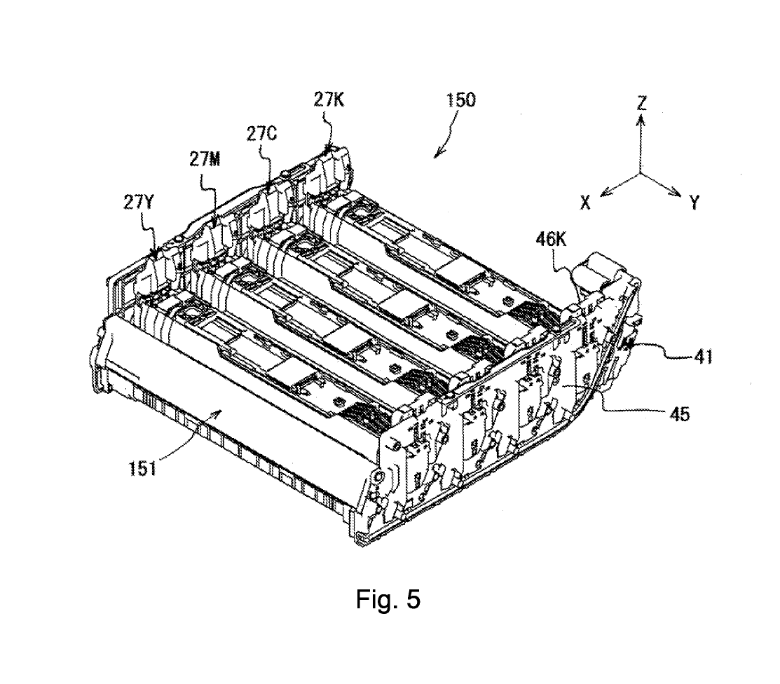

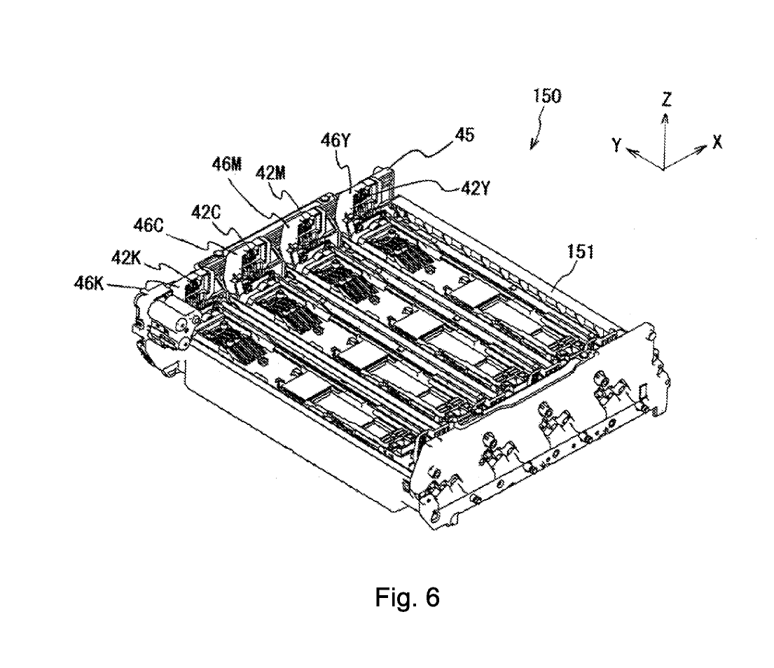

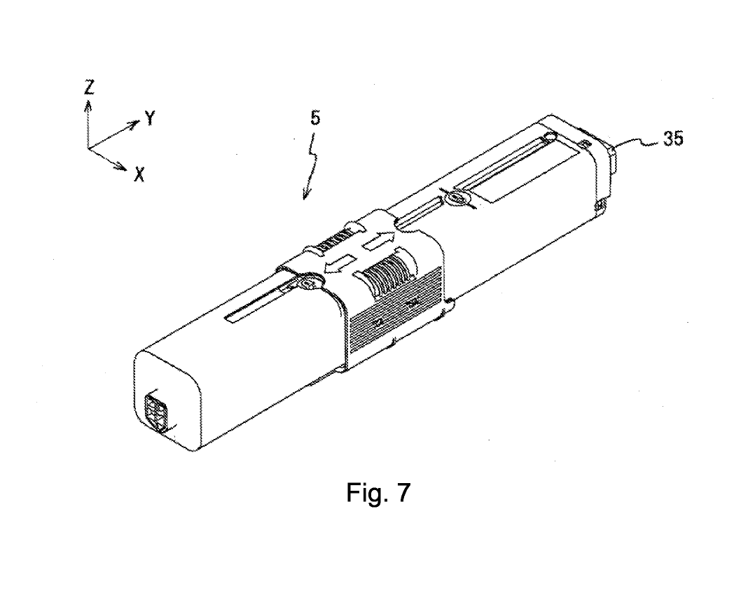

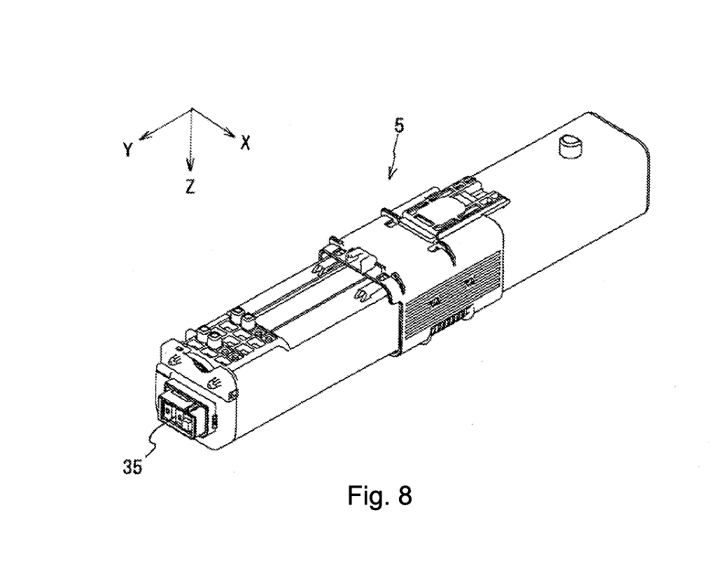

FIGS. 3 and 4 are external perspective views of the development device 150 of the first embodiment according to the present invention seen from different directions. FIGS. 5 and 6 are external perspective views of the development device 150 without the four toner cartridges 5 corresponding to the various colors seen from different directions. FIGS. 7 and 8 are external perspective views of one of the toner cartridges 5 seen from different directions.

As shown in FIGS. 3 and 4, the development device 150 includes the development units 23K, 23C, 23M and 23Y for each color arranged at equal pitches and a basket 151 to surround the development units 23K, 23C, 23M and 23Y. That is, the development device 150 includes the four development units 23 and the basket 151 that integrally holds the development units 23 with certain degree of freedom. The development device 150 is removably installed in the image forming apparatus 100 main body. The development units 23K, 23C, 23M and 23Y for each color removably includes corresponding toner cartridges 5K, 5Y, 5M and 5C (referred to as a toner cartridge(s) 5 unless otherwise specifically distinguished) at the upper part thereof and are configured to receive a supply of unused toner 4 (FIG. 2) from each toner cartridge 5.

FIGS. 5 and 6 illustrate the development device 150 shown in FIGS. 3 and 4, respectively, without the four toner cartridges 5 for the respective colors. As shown in FIG. 5, development unit main bodies 27K, 27C, 27M and 27Y (referred to as a development unit main body(s) 27 unless otherwise specifically distinguished) without the toner cartridges 5 are integrally held in the basket 151. As shown in FIG. 6, a first frame 45 as a holding member that forms one of side parts of the basket 151 and a second frames 46K, 46C, 46M and 46Y (referred to as a second frame(s) 46 unless otherwise specifically distinguished) that form one of side parts of the respective development unit main bodies 27K, 27C, 27M and 27Y are positioned to face each other.

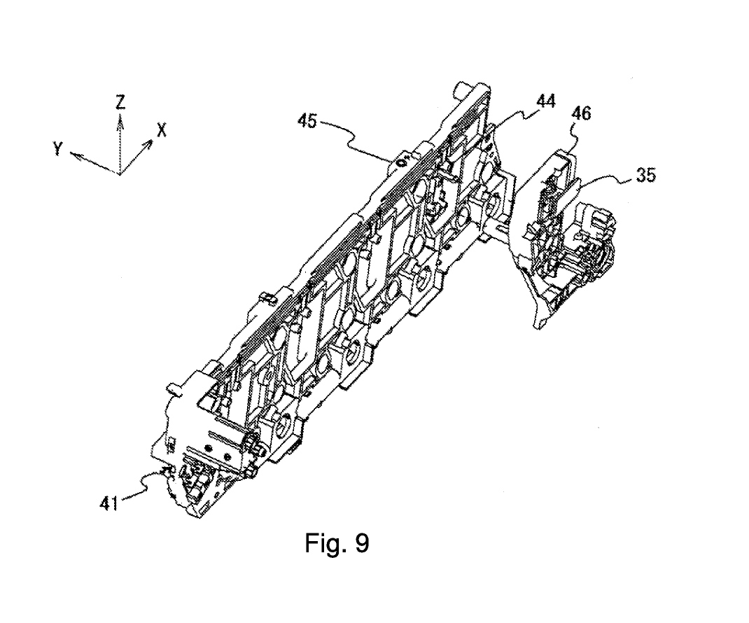

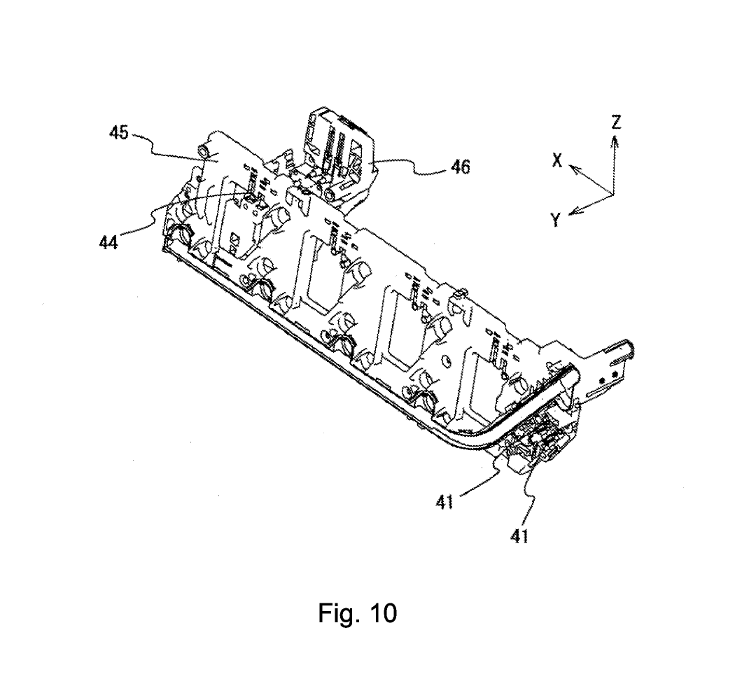

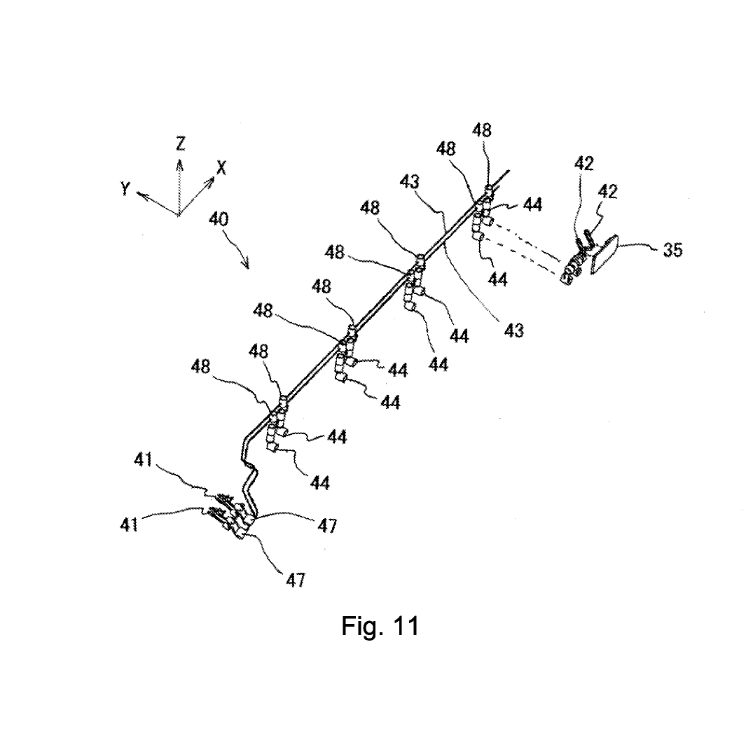

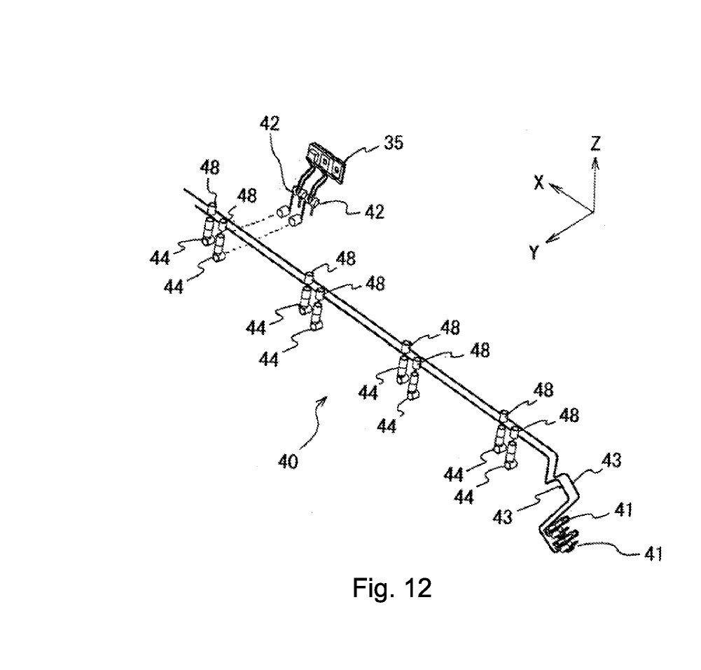

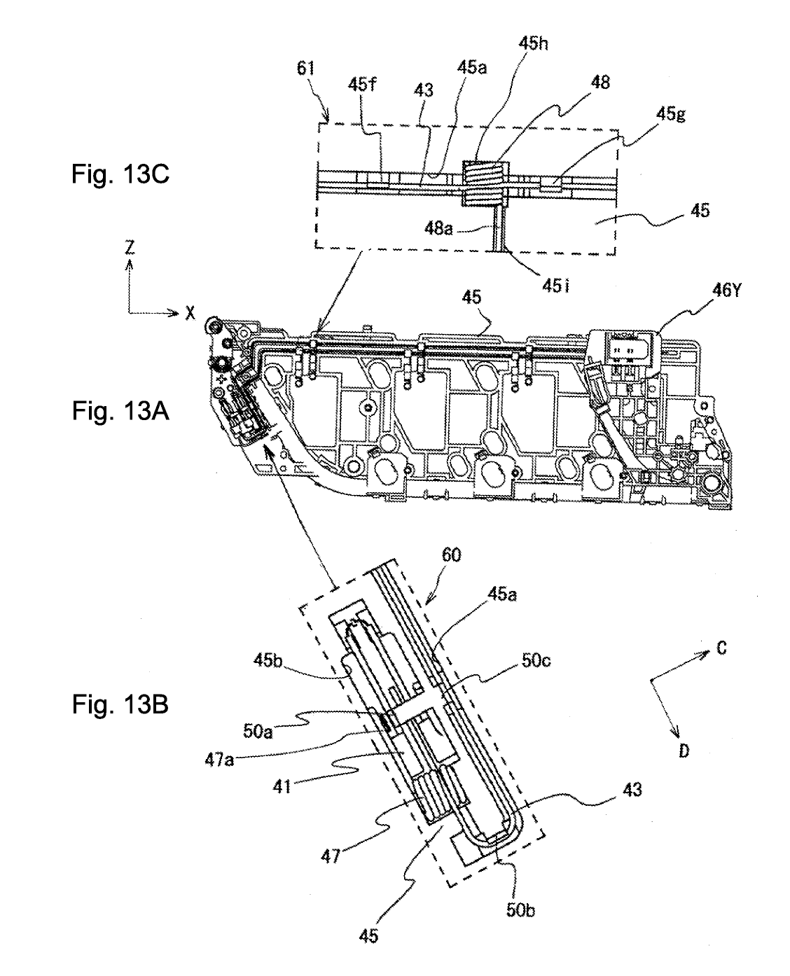

FIGS. 9 and 10 are exploded perspective views illustrating a relative positional relationship between the first frame 45 and the second frame 46 (here only the second frame 46Y is shown) in a slightly separated state. FIGS. 11 and 12 are exploded perspective views illustrating arrangements of an electrical relay contact member 40 provided on the first frame 45 and the second frame 46 in a separated state, as viewed from the same directions as FIGS. 9 and 10, respectively. In addition, FIG. 13A is a configuration diagram of the first frame 45 and the second frame 46 as seen from the inside of a basket (negative side of Y axis). FIGS. 13B and 13C are partially enlarged view respectively enlarging parts indicated by arrows.

The relay contact member 40 is a member that transmits the information by electrically connecting the memory member 35 included in the toner cartridge 5 and the contact member (not shown) included in the image forming apparatus 100 main body. When the toner cartridge 5 Y shown in FIGS. 7 and 8, for example, is installed in the development unit main body 27Y shown in FIG. 5, the memory member 35 of the toner cartridge 5Y is electrically connected to the second torsion spring 42Y included in the second frame 46Y (FIG. 6) that configures the development unit main body 27Y. When the development device 150 shown in FIG. 3 is installed in the image forming apparatus 100 main body, the first torsion spring 41 that extends to the outside from the first frame 45 is electrically connected to the contact member (not shown) included in the image forming apparatus 100 main body.

Here, each memory part 35 of the four toner cartridges 5 is configured to be electrically connected to the contact member of the image forming apparatus 100 via the relay contact member 40 through two systems. The relay contact part 40 is further explained below.

The relay contact member 40 includes first torsion springs 41 included in the first frame 45 that are electrically connectable to the contact member (not shown) equipped in the image forming apparatus 100, first relay members 43 that are configured in the first frame 45 to extend in an arrangement direction of the development unit 24, first connection members 47 that are configured in the first frame 45 and that electrically connect the first torsion springs 41 and the first relay members 43 at junctions, second torsion springs 42 that are configured in the four second frames 46 and that are connectable to the memory member 35 of the corresponding toner cartridge 5, second relay parts 44 that are configured in the first frame 45 facing the second torsion springs 42 and that contact, and are electrically connected to, the second torsion springs 42, and second connection members 48 that are configured in the first frame 45 and that electrically connect the second relay members 44 and the first rely members 43 at junctions. In addition, the two systems are formed electrically independent from each other.

The relay contact member is entirely conductive (made by a conductor). In the relay contact member 40 included in the first frame 45, the first connection members 47 and the second connection members 48 are formed of a coil material having spring characteristics, such as SUS304-WBP as a representative example. The first relay member 43, however, is made of a coil material but may not have the spring characteristics.

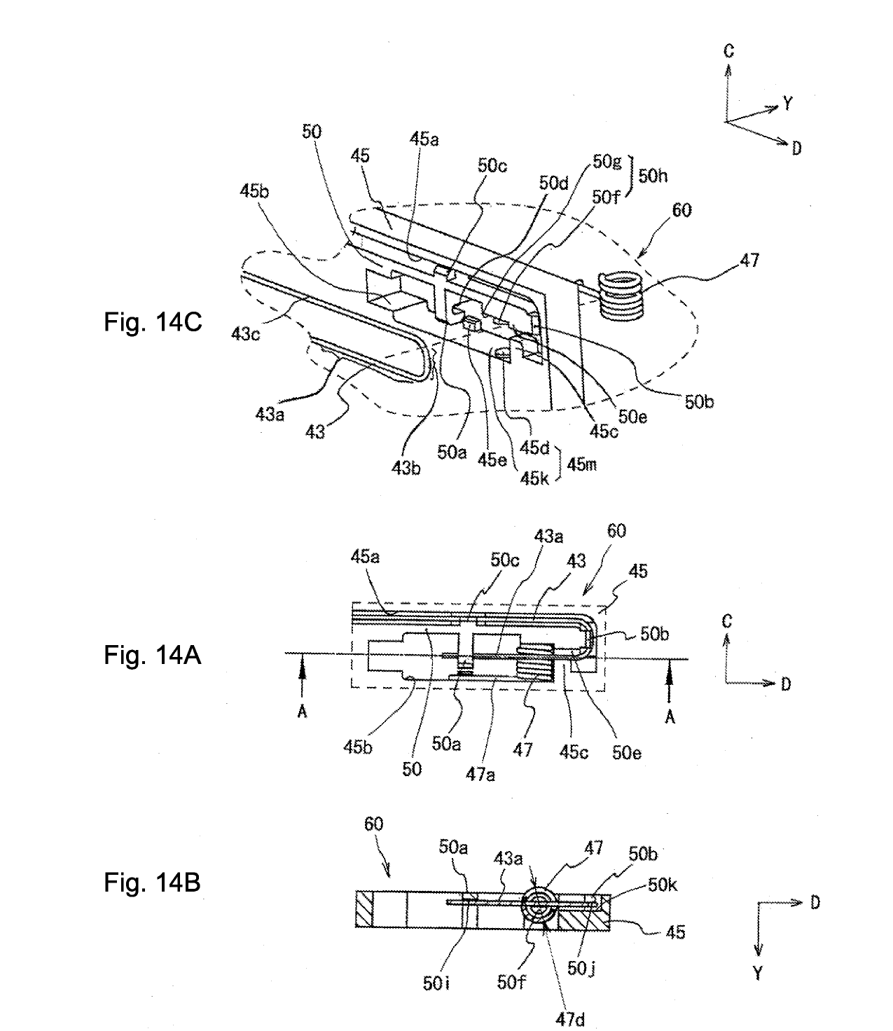

FIG. 13B is partially enlarged view of the configuration of one of the two systems of the first connection members 47 included in the first frame 45 and the first connection part 60 that surrounds the first connection member 47, as cut and shown with the broken line for simplicity. FIG. 14A is a configuration diagram illustrating the same part shown in FIG. 13B as rotated about the Y axis for ease of understanding (however, the first torsion spring 41 is omitted). FIG. 14B is a cross-sectional view of a line A-A in FIG. 14A. FIG. 14C is an exploded perspective view of the same part (first connection part 60). In the plan surface of FIGS. 13B and 14A, the arrow D direction is set in a direction in which the first torsion spring 41 extends, and the arrow C direction is set in the direction orthogonal to the arrow D direction. The Y axis direction is common with the other figures.

The configuration of the relay contact member 40 is further explained below. A guide groove 45a is formed on the first frame 45 at a position where the first relay member 43 is wired. Moreover, in the first connection part 60 shown in FIG. 13B and FIGS. 14A to 14C, a connection opening part 45b that accommodates a linear end part 43a positioned closer to the tip end side than a curve part 43b of the first relay member 43 that curves in a U-shape is formed continuously from the guide groove 45a. The guide groove 45a and the connection opening part 45b are partitioned by a position regulation partition 50 that is formed along the guide groove 45a and that regulates an end part position of the first relay member 43.

This position regulation partition 50 includes a protrusion part 50c, a protrusion part 50b, a regulation part 50e, a regulation part 50d and a protrusion part 50a. The protrusion part 50c protrudes to the guide groove 45a side (arrow C direction) and regulates a position of a curvature part vicinity part 43c of the first relay member 43, which is not a front end side of a curvature part 43b. The protrusion part 50b protrudes to the arrow D side that is orthogonal to the arrow C and regulates a position of the curvature part 43b of the first relay member 43 in the Y axis direction. The regulation part 50e is formed on a connection opening part 45b side facing a regulation part 45 that protrudes from an inner wall of the connection opening part 45b and regulates, together with a regulation part 45c, a position of a linear end part 43a of the first relay member 43, which is near the curvature part 43b, in the arrow C direction. The regulation part 50d protrudes in an L-shape to the connection opening part 45b side. The protrusion part 50a regulates a position of the linear end part 43a of the first relay member 43 in the Y axis direction as the linear end part 43a is inserted in the regulation part 50d. The Y axis direction is parallel with a coil diameter direction the first connection member 47 formed with a compression coil spring.

The regulation part 45c and the regulation part 50e are positioned between the protrusion part 50a and the protrusion part 50b. The first connection member 47 and the first relay member 43 are connected in the vicinity of the regulation part 45c and the regulation part 50e.

In addition, as shown in FIG. 14B, an abutment part 50k is formed on the first frame 45. The abutment part 50k regulates the movement of the relay member 43 in the +Y axis direction. Moreover, the protrusion part 50a includes an abutment part 50i, and the protrusion part 50b includes an abutment part 50j. The abutment part 50i and the abutment part 50j regulate the movement of first relay member 43 in the −Y axis direction (the Y axis direction is defined a coil diameter direction). As a result, the movement of the relay member 43 in the upward-downward and left-right directions is regulated while the linear end part 43a extends in the arrow D direction. The abutment part 50i, the abutment part 50j and the abutment part 50k correspond to regulation members. In the embodiment, the coil diameter direction is illustrated in direction Y as shown in FIG. 14C. The coil diameter direction may be defined other way. A longitudinal direction of the relay member 43 is defined as D direction. Perpendicular to the D direction, a height direction of the coil spring (or connection member 47) is defined as C direction. The coil diameter direction is perpendicular to both of the D and C directions.

A space formed by the abutment part 50k and the abutment part 50j has a large with than a diameter of the relay member 43 and are formed in the vicinity of a center of a diameter 47d of the first connection member 47 formed with a compression coil spring. That is, the abutment part 50k and the abutment part 50j are positioned near the center of the diameter 47d. Here, regarding “near the center of the diameter 47d,” certain effects are obtained as long as the abutment part 50k and the abutment part 50j are positioned from the outer circumference of the compression coil spring within a distance that is 50% of the diameter 47d in the Y axis direction. However, it is preferable that the abutment part 50k and the abutment part 50j are positioned within the distance that is 25% of the diameter 47d.

Here, the first connection member 47 formed with a compression coil spring is attached so as to be inserted at a position between the protrusion part 50a and the regulation part 50e of the regulation partition 50 and adjacent to the regulation part 50e and so that a pair of the protrusion parts 45d and 50f, which are formed to face each other on the inner wall parts of the connection opening part 45b, are inserted into the inner circumference of the respective ends of the coil spring. In addition, the first connection member 47 attached in a state of almost solid coiling with the linear end part 43a of the first relay member 43 between winding wires.

As shown in FIG. 14C, the first connection member 47 formed with the compression coil spring is held by a pair of a holding member 50h and a holding member 45m. In this embodiment, the a pair of holding member 50h and holding member 45m configures a holding member. The holding member 50h includes the protrusion part 50f and an abutment part 50g. As the protrusion part 50f goes into a ring formed by the compression coil spring so that the protrusion part 50f and the compression coil spring engage with each other, the movement of the compression coil spring in the arrow D direction and the Y axis direction is regulated. In addition, as the abutment part 50g and the compression coil spring contact each other, the movement of the compression coil spring in the arrow C direction (or height direction of the coil spring) is regulated. The holding member 45m includes the protrusion part 45d and the abutment part 45k. The regulation for the compression coil spring is similar to the case of the above-described holding member 50h. Herein, direction C in FIG. 14C is defined as the winding direction of coil.

At this time, the first relay member 43 is electrically connected to the first connection member 47 via the linear end part 43a. Additionally, the electrical connection relationship is stabilized because the movement of the first connection member 47 in the arrow C direction and the Y axis direction is regulated at both ends of this connection part.

Moreover, the first connection member 47 includes a linear end part 47a that extends from the protrusion part 45d side of the coil spring part. The linear end part 47a extends along the inner wall of the connection opening part 45d and is locked by the protrusion part 45e formed on the inner wall of the connection opening part 45b. As shown in FIG. 13B, the linear end part 47a of the connection member 47 is pressed against the first torsion spring 41 positioned in the first connection part 60 and thereby electrically connected to the first torsion spring 41.

On the other hand, FIG. 13C is a partially enlarged view of a configuration of one of two systems of second connection members 48 included in the first frame 45 facing the four toner cartridges 5, and a second connection part 61 surrounding the second connection member 48 clipped and indicated with dotted lines.

Also in the second connection part 61, the guide groove 45a is formed at a position on the first frame 45 where the first relay member 43 is wired. In addition, a housing part 45h, which accommodates the second connection member 48 formed with a compression coil spring in a state of almost solid coiling is formed at a position where the second connection member 48 is positioned. Protrusion parts (not shown) are formed facing each other at positions on the upper and lower wall pats of the housing part 45h and fixes the second connection member 48 by inserting the protrusion parts into the inner circumference part of respective end parts of the second connection member 48. To insert and fix the second connection member 48 in the housing part 45h, the first relay member 43 is inserted and attached between the winding wires of the second connection member 48. As a result, the first relay member 43 and the second connection members 48 are electrically connected to each other.

Moreover, the movement of the first relay member 43 in its extension direction and a direction (Y axis direction) orthogonal with the extension direction is restricted (or positionally restricted) by the position regulation members 45f and 45g formed on the first frame 45 on the both sides of the part connecting to the second connection member 48. Therefore, the electrical connection relationship with the second connection member 48 is stabilized. The both sides of the connection member are defined as both sides of a predetermined section that is linearly formed.

Further, the second connection member 48 includes a lower end part 48a that extends from a lower side of the coil spring part. The lower end part 48a extends downwardly along a guide groove 45i formed on the first frame 45 and is configured to electrically connect to the second relay member 44 (FIG. 11).

Based on the above configurations, operation of the image forming apparatus 100 is first explained with reference to FIG. 1.

When printing is started, the image forming apparatus 100 feeds a recording sheet from the sheet supply cassette 20 by the sheet feeding part 22 and carries the recording sheet to the downstream along the sheet carrying path 15. While carrying the recording sheet, the thickness of the recording sheet is detected by the detection part 26 that detects a thickness of a sheet. In the subsequent carrying process by the carrying belt unit 24, toner images formed individually by the development units 23K, 23C, 23M and 23Y are sequentially superimposed and transferred onto the recording surface of the recording sheet by the transfer roller 12. In addition, after fixing the toner images onto the recording surface by a fuser 25, the printed recording sheet is carried to the stacker 21.

Next, operation of the development unit 23 (development unit 23K is shown as an example) at this time is explained below with reference to FIG. 2.

In the development unit 23, the toner 4 supplied from the toner cartridge 5 is supplied onto the development roller 6 by the toner supply roller 8. The toner 4 supplied onto the development roller 6 is made in a uniform thickness by the development blade 7. Then, the electrolatent static image formed on the photosensitive body 1 by the exposure device 3 is visualized, that is, developed by the uniformly formed toner 4. The developed toner 4 is electrically transferred to the recording medium 13 by the transfer roller 12. The residual toner 4 that was not transferred onto the recording medium 13 and remained on the surface of the photosensitive body 1 is scraped by the cleaning blade 9 and accumulated in a waste toner collection part 92.

Next, features of the connection mechanism of the first connection part 60 shown in FIG. 13B is further explained with reference to FIGS. 13A and 14C.

The main part of the first connection member 47, of which the extending linear end part 47a electrically contacts the first torsion spring 41, is formed with formed with a compression coil spring. The first connection member 47 is attached to the connection opening part 45b of the first frame 45 while being compressed in a state of almost solid coiling. As a result, the first connection member 47 turns in a state that both ends of the coil spring part press the opposing inner wall parts of the connection opening part 45b. As discussed above, the first connection member 47 is positioned as the pair of protrusion parts 45d and 50f (FIG. 14C) formed to face each other on the inner wall part of the connection opening part 45b and the position regulation partition 50 are inserted into the inner circumference part of both ends of the coil spring part.

Therefore, when the first relay member 43 is sandwiched between the winding wires of the coil of the first connection member 47 that has been compressed almost to the solid coiling state, the first connection member 47 holds the first relay member 43 while applying pressure to the first relay member 43. Thus, the first relay member 43 is electrically connected. At this time, because the pressure to the first frame 45 by the first connection member 47 increases, the attachment of the first connection member 47 is more secured. Moreover, the first connection member 47 and the first relay member 43 are connected at two locations when the first connection member 47 sandwiches the first relay member 43 (see FIG. 14B). Therefore, stable holding of the first relay member 43 by the first connection member 47 and stable electrical connection therebetween are achieved.

Further, as discussed above, because the first relay member 43 is restricted from moving by the first frame 45 near the both sides of the electrical connection part with first connection member 47, the electrical connection relationship with the first connection member 47 is more stabled, and the first connection member 47 that sandwiches the first relay member 43 is prevented from being dislocated from the first frame 45.

On the other hand, also in the connection mechanism of the second connection part 61 shown in FIG. 13B, the main part of the second connection member 48, of which the extending lower end part 48a electrically contacts the second relay member 44, is formed with a compression coil spring. The second connection member 61 is attached to the housing part 45h of the first frame 45 while being compressed in a state of almost solid coiling. As a result, the second connection member 48 turns in a state that both ends of the coil spring part press the opposing inner wall parts of the housing part 45h.

Therefore, when the first relay member 43 is sandwiched between the winding wires of the coil of the second connection member 48 that has been compressed almost to the solid coiling state, the second connection member 48 holds the first relay member 43 while applying pressure to the first relay member 43. Thus, the first relay member 43 is electrically connected. At this time, because the pressure to the first frame 45 by the second connection member 48 increases, the attachment of the second connection member 48 is more secured. Moreover, the second connection member 48 and the first relay member 43 are connected at two locations when the second connection member 48 sandwiches the first relay member 43. Therefore, stable holding by the first connection member 47 and stable electrical connection therebetween are achieved.

Further, as discussed above, because the first relay member 43 is restricted from moving by the first frame 45 near the both sides of the electrical connection part with the second connection member 48, the electrical connection relationship with the second connection member 48 is stabled, and the second connection member 48 that sandwiches the first relay member 43 is prevented from being dislocated from the first frame 45.

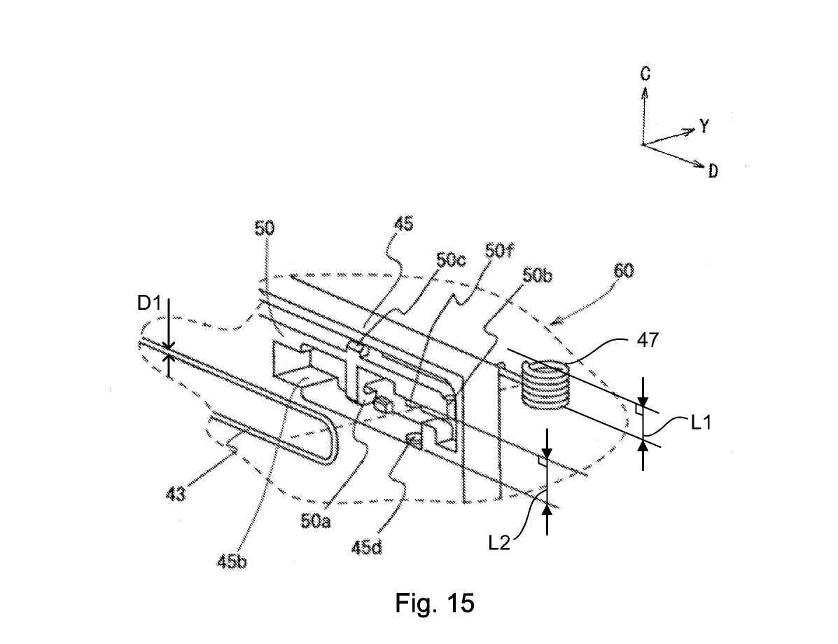

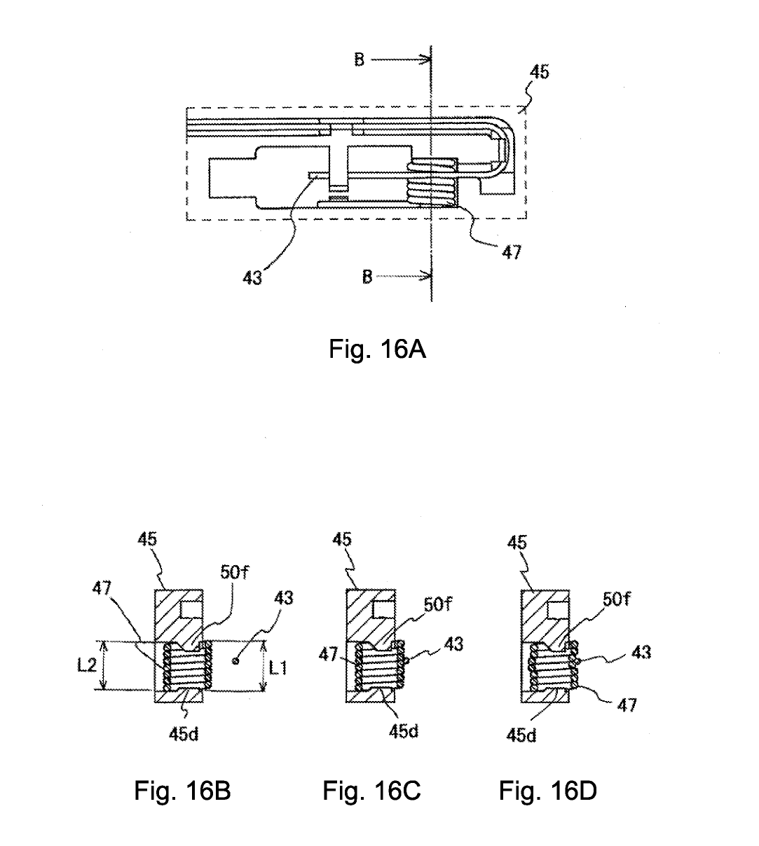

FIG. 15 is a dimensional diagram of the first connection part 60 shown in FIG. 14C. FIGS. 16A to 19D are diagrams for explaining mounting dimensions. In FIGS. 16A to 19D, FIGS. 16A, 17A, 18A and 19A are configuration diagrams viewed from the same position as FIG. 14A. FIGS. 16B, 16C, 16D, 17B, 17C, 17D, 18B, 18C, 18D, 19B, 19C and 19D show each state at the time of mounting at a position corresponding to the B-B cross section in FIGS. 16A, 17A, 18A and 19A.

As shown in FIG. 15, where the solid coiling height of the coil spring part of the first connection member 47 is L1, a wire diameter of the first relay member is D1, and a mounting width between opposing wall surfaces of the connection opening part 45b of the first frame 45 on which the first connection member 47 is mounted is L2, each dimension is preferably configured so as to meet the following equation:

L1<L2≦L1+D1 (1)

Reasons for this are explained below.

FIGS. 16B, 16C and 16D illustrate mounting states when L1≧L2. At this time, the first connection member 47 is assembled in a state that the first connection member 47 is press-fit in, or closely attached to, the first frame 45. Therefore, a space is not generated between the winding wires of the coil of the first connection member 47 as shown in FIG. 16C. With this state, the first relay member 43 cannot be inserted in the first connection member 47. Therefore, L1 and L2 need to be L1<L2 in order to mount the first connection member 47 in the first frame 45.

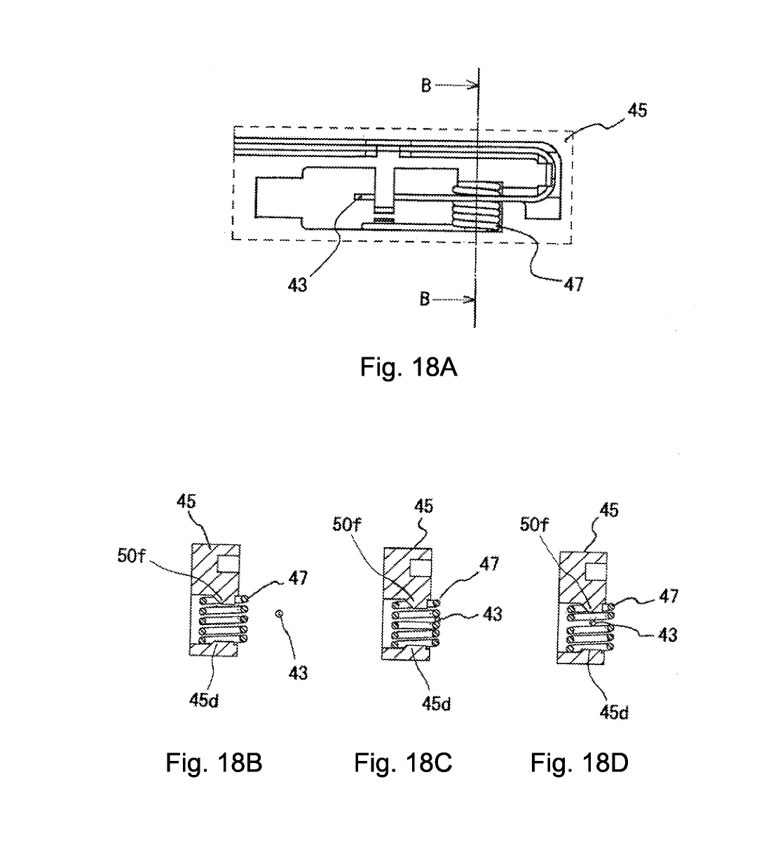

On the other hand, 18B, 18C and 18D illustrate mounting states when L2>L1+L2. At this time, the first connection member 47 is not compressed to solid coiling as shown in FIG. 18D even if the first relay member 43 is sandwiched. With this state, the contact between the first connection member 47 and the first relay member 43 may be insufficient. To avoid this state, the relationship between the first connection member 47, the first relay member 43, and the first frame 45 need to be L2≦L1+D1.

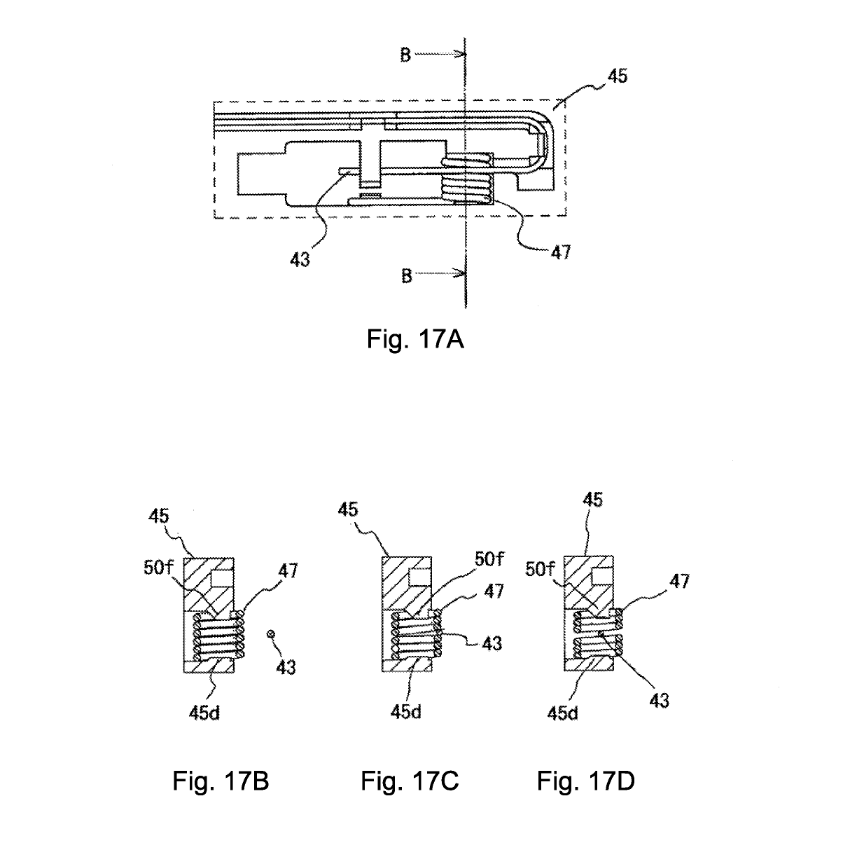

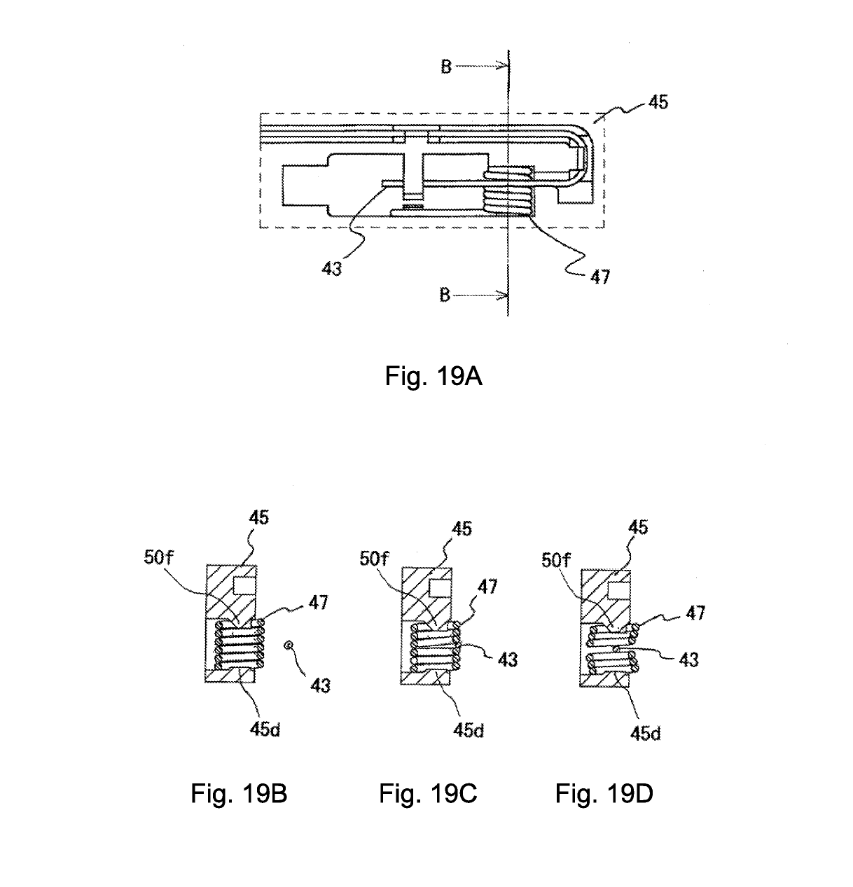

FIGS. 17B, 17C and 17D illustrate mounting states when L1<L2=L1+D1. In this case, when the first relay member 43 is sandwiched in the first connection member 47, the first connection member 47 widens to the size L2 of the first frame 45 and thereby sandwiches the first relay member 43 in the solid coiling state. FIGS. 19B, 19C and 19D illustrate mounting states when L1<L2<L1+D1. With such configuration, in the process of sandwiching the first relay member 43, the first connection member 47 widens to the size L2 of the first frame 45 as shown in FIG. 19C and further deforms as shown in FIG. 19D thereafter due to press-fitting, allowing the first relay member 43 to be sandwiched.

Therefore, as shown in FIGS. 17B to 17D and 19B to 19D, excellent mounting of the first connection member 47 and the first relay member 43 and excellent electrical connection relationship therebetween are achieved by setting the solid coiling height L1, the wire diameter D1 of the first relay member, and the mounting width L2 between opposing wall surfaces to meet the above-equation (1). The wire diameter D1 of the first relay member 43 and the wire diameter of the first connection member 47 preferably range from 0.4 mm to 1.2 mm. In other words, the wire diameters of these members preferably range from 10% to 20% of the solid coiling height L1. Of the materials of the relay member and connection member, it is preferred that the transverse elastic module substantially ranges from 55 to 85 GPa, and that the longitudinal elastic module substantially ranges from 180 to 210 GPa. That is for reducing a degree of deformations while the members are assembled, and for making the contact area between the members large enough. It is also for reducing occurrence of cracks (flaw, fractures etc.) due to a long term operation.

In the present embodiment, the mounting mechanism according to the present invention was used for the relay contact member 40 that transmits information by electrically connecting a memory member, such as a non-volatile memory (RFID) and the like, included in a toner cartridge and a contact member (not shown) included in the image forming apparatus 100 main body. However, the embodiment is not limited to this and may be used as a contact for conducting electric current from a high voltage circuit board.

In addition, the present embodiment was explained by using a configuration in which the four development units 23 are installed in the image forming apparatus 100 main body while being together held in a basket. However, the present embodiment is not limited to this. The development units 23 may be configured directly installable/detachable with respect to the image forming apparatus 100.

Furthermore, in the present embodiment, the second connection member 48 and the second relay member 44 are explained as separate members. However, the present embodiment is not limited to this. Various forms are possible, such as by integrally forming the second connection member 48 and the second relay member 44 by processing a coil spring.

As discussed above, according to the first and second connection parts, which are mounting mechanisms of the present embodiment, the first connection member 47 and/or the second connection member 48, which are configured with coil springs, secure stable mounting state and simultaneously electrical connection relationship when mounting the first relay member 43 formed of a coil material in the first frame 45 in a electrically connected state. Moreover, because the relay contact member 40 has a simple configuration by using the coil material, the present invention is easily applicable even when there are multiple junctions as discussed in the present embodiment. Further, the present invention can contribute to reducing the cost if the coil material is used because a specific hard tooling is not required.

In the above described embodiment, an example in which the present invention is implemented in an electrographic printer was described. However, the present embodiment is not limited to this and may be used in multi-function printers (MPF), facsimile machines, photocopy machines and the like.

What is claimed is:

1. A connection mechanism, comprising:
a connection member including a coil spring part and made by a conductor;
a holding member that is configured to hold the coil spring part in a compressed state; and
a relay member that is electrically connectable to the connection member, wherein
the relay member is sandwiched between adjacent winding wires of the coil spring part to establish electrical connection.

2. The connection mechanism according to claim 1, wherein
a predetermined section of the relay member is linearly formed and includes a connection part that is electrically connected to the coil spring part, and
both sides of the connection part, which are linearly formed, are positionally restricted by the holding member.

3. The connection mechanism according to claim 1, wherein
the both ends of the connection part are engaged with the winding wires of the coil spring part so that the electrical connection between the relay member and the coil spring part is stabilized.

4. The connection mechanism according to claim 1, wherein
where a solid coiling height of the coil spring part is L1, a wire diameter of the relay member is D1, and a distance between contact parts that contact respective ends of the coil spring part is L2, L1, D1 and L2 are configured so as to meet the following relationship:
L1<L2≦L1+D1.

5. The connection mechanism according to claim 1, wherein
the wire diameter (D1) of the relay member ranges from 10% to 20% of the solid coiling height (L1) of the coil spring part.

6. The connection mechanism according to claim 5, wherein
the wire diameter (D1) of the relay member ranges from 0.4 mm to 1.2 mm.

7. The connection mechanism according to claim 1, wherein
the holding member is configured with a pair of contact parts which are opposing each other in a height direction of the coil spring, and respectively contact ends of the coil spring part, and
a pair of protrusion parts are respectively disposed on the contact parts and are inserted in inner circumference parts of the coil spring part.

8. The connection mechanism according to claim 1, wherein
the connection member includes a plurality of connection members.

9. The connection mechanism according to claim 1, wherein
the connection member includes a linear end part that extends from the coil spring part.

10. The connection mechanism according to claim 1, wherein
the relay member is formed of a coil material.

11. The connection mechanism according to claim 2, further comprising:
at least two regulation members that regulate movement of the relay member in a coil diameter direction of the connection member, wherein
the connection part is provided between adjacent ones of the regulation members.

12. The connection mechanism according to claim 2, further comprising:
a regulation part that regulates movement of the relay member in a coil winding direction of the connection member, wherein
the relay member is engaged with the regulation part in the vicinity of the connection part.

13. A development device to which a toner cartridge is installed, comprising:
a connection mechanism that comprises:
a connection member including a coil spring part and made by a conductor;
a holding member that is configured to hold the coil spring part in a compressed state; and
a relay member that is electrically connectable to the connection member, wherein
the relay member is sandwiched between adjacent winding wires of the coil spring part to establish electrical connection, and
electrical connection with the installed toner cartridge is established by the connection mechanism.

14. The development device according to claim 13, wherein
information of the toner cartridge is transmitted by the connection member.

15. A development device to which a toner cartridge is installed, comprising:
a connection mechanism that comprises:
a connection member including a coil spring part and made by a conductor;
a holding member that is configured to hold the coil spring part in a compressed state; and
a relay member that is electrically connectable to the connection member, wherein
the relay member is sandwiched between adjacent winding wires of the coil spring part to establish electrical connection, and
electrical connection with the installed toner cartridge is established by the connection mechanism.

16. The image forming apparatus according to claim 15, wherein
information of the toner cartridge is transmitted by the connection member.
